(19) United States
(12) Patent Application Publication
(10) Pub. No.: US 2011/0253638 A1
(43) Pub. Date: Oct. 20, 2011

(54) SYSTEMS AND METHODS FOR REDUCING ELECTRIC POWER BY OPTIMIZING WATER TURBIDITY, SUSPENDED SOLIDS, CIRCULATION AND FILTRATION IN POOLS, SPAS, WATER FEATURES, AND OTHER CLOSED BODIES OF WATER

(75) Inventors: Steven Richard Easland, Riverside, CA (US); Mark William Easland, Dana Point, CA (US)

(73) Assignee: BREAKPOINT COMMERCIAL POOL SYSTEMS INC., RIVERSIDE, CA (US)

(21) Appl. No.: 13/168,806

(22) Filed: Jun. 24, 2011

Related U.S. Application Data
(60) Provisional application No. 61/358,255, filed on Jun. 24, 2010.

(51) Int. Cl. E04H 4/12; C02F 1/00; C02F 103/42

(52) U.S. Cl. 210/745; 210/85; 210/96.1

(57) ABSTRACT

One feature of the present invention provides a method for optimizing water filtration in a closed body of water. The method includes circulating the water through a closed loop filtration system to remove contaminates, where a pump forces the water from the closed body of water through plumbing to a filter; measuring a clarity of the water passing through the plumbing using one or more sensors connected to the plumbing; providing an output of the one or more sensors to a system controller operatively coupled to a motor of the pump, via a motor controller for comparing the measured water clarity to a desired water clarity to determine an optimal filter rate and time to achieve the desired water clarity; and providing power to the motor, via the motor controller, driving the motor to operate the pump at the optimal filter rate and time.

### CLAIM OF PRIORITY UNDER 35 U.S.C. §119

The present application for patent claims priority to U.S. Provisional Application No. 61/358,255 entitled “Systems and Methods for Saving Power by Optimizing Water Circulation and Filtration in a Closed Body of Water”, filed Jun. 24, 2010, and hereby expressly incorporated by reference herein.

### FIELD

One feature relates to a closed loop circulation/filtration system for optimizing water circulation and filtration in closed bodies of water, including but not limited to, swimming pools, spas, and water features by automatically filtering the body of water based on a predetermined water clarity level. so that only necessary and sufficient filtering occurs. The closed loop circulation/filtration system greatly reduces energy consumption by only producing necessary and sufficient filtering.

### BACKGROUND

Today, man-made bodies of water, like swimming pools, spas and water features, utilize plumbing and various systems to extract water-borne contaminates from the water. That is, the water circulates through a filter which helps remove contaminates such as algae and harmful pathogens.

Circulation/filtration systems can be utilized to keep the water moving, provide a way to add chemicals, such as chlorine and acid, to continually clean the water, keep it safe and remove contaminates borne by swimmers and by nature (primarily wind), such as dirt, dust, pollen and spores, which find their way into the water. This is accomplished by pumping the water in a continual cycle from the body of water through the circulation/filtration system, a heater (optionally), and back into the body of water again. The circulation/filtration system also allows for the pH level of the water to be maintained, for example between 7 and 7.5, by introducing acids or alkalines (bases) into the moving water, causing the acids or alkalines (bases) to be dispersed into the body of water. Additionally, the circulation/filtration system may be a part of an oxidation system that maintains Free Available Chlorine between 1 and 5 ppm, or other levels as defined by state or local laws.

Specifically, when filtering water in a public pool, a filtering “rule of thumb”, (now coded into local and/or state health code regulations), is typically used. The “rule of thumb” typically indicates that a swimming pool filtration system “must be capable of a 6 hour turnover”. That is, all the water in the swimming pool (or more accurately, the equivalent volume) must pass through a filter in a certain amount of time, often specified for pools as six (6) hours. Regulations sometimes specify that spas and wading pools must generally be capable of between 0.5 and 2 hour turnovers, which varies from location to location. For example, a large public pool may contain 167,000 gallons (630,000 liters) of water. A “6 hour turnover” results in 167,000 gallons (630,000 liters) of water having to be pumped through a filtration system every six (6) hours.

The exact origins of the six (6) hour “rule of thumb” are shrouded in mystery. In the mid-1980s at least in some states, the “rule of thumb” was 8 hours. Some say calculations based on worst case hot day, worst case bathing loads, worst case chlorine levels, and at least some defecation (human liquid and solid waste) in the pool indicated that 6 hours filter rate was needed. But like any “rule of thumb” based on worst case conditions, little or no science or engineering is contained in it. A better, more exacting method is needed, based on science, engineering and repeatable results.

This 6-hour turnover “rule of thumb” has several flaws. It is fixed, and as such lacks any appreciation that conditions change. Pool swimmer load changes. Weather conditions change. There are variations dependent upon the time of year, and yet the rule of thumb and the associated turnover value remains fixed. This fixed standard does not provide an accurate and energy efficient means for filtering the water. In some states, the exact hours that the pump/filter is to be powered are not defined and therefore it is open to interpretation. As it is open to interpretation, the rate of the pump, as well as the number of hours the pump operates at this rate is unknown. Furthermore, there is no adjustment based on time of year or the conditions or situation of a particular day. For example, the pump will operate at the same rate that it does in winter as it does in summer and as well as if the pool is open or closed resulting in a waste of energy. As a result, it can be expected that filtration systems across the country are being used too long most of the time and too little at other times resulting in the water being either over or under filtered. Under filtered water is cloudy (turbid or containing suspended solids, discussed in more detail below) while over filtered water would be clear (not turbid), but achieved at an unnecessarily high electrical cost. In general, given proper chemical balance, more filtering reduces turbidity while less filtering leaves water turbid. Furthermore, current filtration systems used in pools are open loop with regard to cloudiness (turbidity) meaning there are no methods of measuring and optimizing filtering to achieve necessary and sufficient circulation and filtering, with a minimum use of electrical energy.

The turbidity of the water and/or the “suspended solids” in the water can be measured to determine the clarity of the water. Turbidity measures the cloudiness or haziness of the water caused by a sum of individual particles that are generally invisible to the naked eye, similar to smoke in the air whereas suspended solids may be visible or invisible to the naked eye. Currently, in public closed body of waters, turbidity and/or suspended solids are not typically measured and therefore not used in a closed loop way to control and modify filter times and/or filter rates. Therefore, the amount of turbidity in pools, spas and water features at any particular moment, is unknown and unpredictable. As a result, the length of time, as well as the amount of filtering to correct the situation, is not based on science, but is rather somewhat arbitrary. While the “6 hour turnover” rule of thumb (now codified into health codes) provides guidance, it does not and cannot take into account variable conditions.

Consequently, today's practice of estimating (in terms of time) and filtering rates, (based on a rule of thumb) is ineffective from a water clarity and/or quality perspective and inefficient (in using electrical power) since no optimization of the filtration system is provided. Most filter systems today include a time clock which allows an operator to set the pump to run for a specified amount of time, however, the time clock cannot, and does not, dynamically adjust the filtration system based on the turbidity or suspended solid value of the water. Without a means by which the clarity of the water can be measured or assured, operators in the public pool industry today have been known to leave the circulation pumps on 24 hours a day, 365 days per year—a tremendous use and waste of electrical energy.

In view of the above, what is needed is a closed loop circulation/filtration system that measures the clarity (turbidity or suspended solids) of the water and adjusts the filtration system based on the clarity of the water to provide both effective and efficient water circulation and filtration.

### SUMMARY

The systems and methods of the present invention are not substitutes for state of the art chemical controllers, but rather a means to improve upon water quality, specifically turbidity/suspended solids, using vastly lower electric energy than present state of the art systems.

The level of filtering of the water needed is determined by the use of water sensors (turbidity and/or suspended solids) in common use in other industries, namely domestic water systems and water pollution monitoring, but used in a unique and original way in swimming pools, spas, water features and other closed bodies of water. The resulting closed loop circulation/filtration system of the present invention not only produces necessary and sufficient filtering, but does so at greatly reduced energy consumption.

One feature of the present invention provides a method for optimizing water filtration in a closed body of water. The method includes circulating the water through a closed loop filtration system to remove contaminates, where a pump forces the water from the closed body of water through plumbing to a filter; measuring a clarity of the water passing through the plumbing using one or more sensors connected to the plumbing; providing an output of the one or more sensors to a system controller operatively coupled to a motor of the pump, via a motor controller for comparing the measured water clarity to a desired water clarity to determine an optimal filter rate and time to achieve the desired water clarity; and providing power to the motor, via the motor controller, driving the motor to operate the pump at the optimal filter rate and time.

The one or more sensors include at least one of a turbidity sensor and a suspended solids sensor and measure the turbidity in the water. The motor can include, for example, a single speed motor, a multiple speed motor and a variable speed motor and can be an alternating current motor (AC) or a direct current (DC) motor. Determining the optimal filter rate and time can include selecting a speed in which to run or stop the motor and selecting a length of time in which to run the motor.

Additionally, the method may include determining if a chemical clarifier (deflocculant) is to be dispersed into the water to obtain the desired water clarity; and providing a command signal to a clarifier chemical and dispenser module if a determination is made to disperse the chemical clarifier into the water.

Another feature of the present invention provides a filtration system for optimizing water filtration in a closed body of water. The filtrations system include means for circulating the water through a filtration system to remove contaminates, where a pump forces the water from the closed body of water through plumbing to a filter; means for measuring a clarity of the water passing through the plumbing using one or more sensors connected to the plumbing; means for providing an output of the one or more sensors to a system controller operatively coupled to a motor of the pump, via a motor controller for comparing the measured water clarity to a desired water clarity to determine an optimal filter rate and time to achieve the desired water clarity; and means for providing power to the motor, via the motor controller, driving the motor to operate the pump at the optimal filter rate and time.

Yet another feature of the present invention provides a controller module for optimizing water filtration in a closed body of water. The controller module includes a memory device; a receiver coupled to the memory device, the receiver for receiving data from one or more sensors; and a processing circuit coupled to the memory device and the receiver. The processing circuit may be configured to receive a measured water clarity from the one or more sensors, the measured water clarity identifying turbidity in water in a closed body of water; determine an optimal filter rate and time to achieve a desired water clarity in the closed body of water by comparing the measured water clarity to the desired water clarity; and drive a motor, via a motor controller, to operate a pump at the optimal filter rate and time for filtering the water.

Additionally, the processing circuit may be configured to determine if a chemical clarifier is to be dispersed into the water to obtain the desired water clarity; and provide a command signal to a clarifier chemical and dispenser module if a determination is made to disperse the chemical clarifier into the water. The command signal can be transmitted to the clarifier chemical and dispenser module via a second transmitter where the second transmitter is coupled to the processing circuit. The control signals can be transmitted to the motor controller via a first transmitter where the first transmitter is coupled to the memory device and the processing circuit.

Determining the optimal filter rate and time can include selecting a speed in which to run or stop the motor and selecting a length of time in which to run the motor. The optimal filter rate and time can be determined locally within the controller or in a network environment.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 is a block diagram illustrating the functional components of a water filtration system according to one example.

FIG. 2 illustrates a block diagram of an internal structure of a system controller module according to one example.

FIG. 3 illustrates a method operational on a controller module for optimizing water filtration in a closed body of water.

FIG. 4 illustrates a method for optimizing water filtration in a closed body of water.

FIG. 5 is a graph illustrating the turbidity (specified in Nephelometric Turbidity Units (NTU)) in a closed body of water over twenty four (24) hours using conventional filtering methods and the closed loop control filtration system of the present invention.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams, or not be shown at all, in order not to obscure the embodiments in unnecessary detail. In other instances, well-known circuits, structures and techniques may not be shown in detail in order not to obscure the embodiments.

In the following description, certain terminology is used to describe certain features. The term “body of water” includes, but is not limited to, public and non-public swimming pools, spas, and water features.

### Exemplary Filtration System

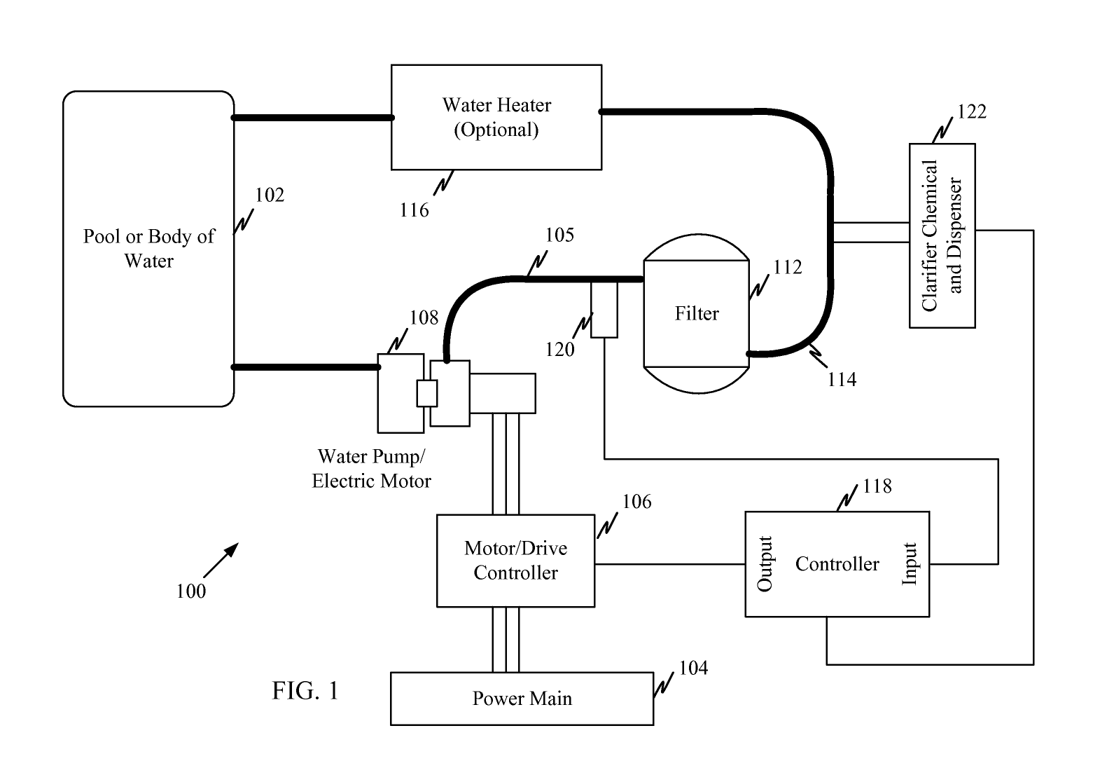

FIG. 1 is a block diagram illustrating the functional components of a water filtration system according to one example. The water filtration system 100 may be operable with any closed body of water 102, including but not limited to, a swimming pool, spa, and water feature.

The water in a closed body of water 102 generally circulates through a filtration system, to remove dirt, debris and other contaminates. In a swimming pool, during normal operation, water circulates to the filtration system through one or more suction points (main drains) at the bottom of the body of water 102 as well as additional suction points such as skimmer, gutters, drains, etc. around the top of the body of water. There may be, and often are, multiple plumbed loops containing one or more filters, one or more motor/pumps, and one or more drains or skimmers which results in one or more turnover filter rates for the body of water. All of these systems may be closed loop controlled with one or more sensors and one or more controllers in like fashion.

In the system 100, power 104 may be supplied to a motor/drive controller 106, such as a variable-frequency drive (VFD) or DC drive (DCD) such as a Silicon Controlled Rectifier (SCR), Thyristor, Pulse Width Modulation (PWM) Controller, or chopper drive, or a contactor set for controlling or driving the electric motor. The electric motor may be an alternating current (AC) or direct current (DC) electric motor. The electric motor may be a single or multiple speed motor, controlled with drives or contactors. In any case, the electrical motor may drive a pump 108 by controlling the characteristics (frequency, voltage or on/off) of the electrical power supplied to the motor.

Turning the pump 108 on may cause water to be pumped from the body of water 102 and driven through plumbing 105 and then through a filter 112 to filter out contaminates in the water. The filter 112 may be a sand filter, a diatomaceous earth filter, a cartridge filter or any other type of filter known in the art.

From the filter 112, the water may be returned to the body of water 102 via one or more water outlets 114, also known as “returns.” Optionally, the filtered water may pass through a water heater 116 prior to returning to the body of water 102.

A system controller module 118, operatively coupled to the motor/driver controller 106, such as VFD (or DCD in the case of a DC motor), may provide control signals to the motor controller 106 (for example VFD/DCD) which in turn may drive the motor to operate the pump 108 at an optimal filter rate and/or time. The optimal filter rate and/or time may be a determination of the most cost efficient and energy efficient way of operating the motor. That is, it drives the filtration system causing it to use the minimum amount of energy, given the type of motor single or multiple speed, or variable speed, to maintain the turbidity or suspended solids at a specific level. For example, it may be more cost effective and energy efficient to have the motor operate at a lower speed for a longer amount of time instead of having the motor operate at a higher speed for a short time. The system controller module 118 or motor/drive controller 106 may compute the best (i.e. lowest cost or most efficient) method of filtering the body of water given technical and operational conditions and requirements.

For single speed motors, the motor can be driven or commanded to be on for a short time from time to time over the course of the day. During these times, turbidity and/or suspended solids, can be measured and addressed automatically by using the present described system. Or in the case of the multiple speed motor (most often 2 or more speeds), a lower speed can be selected either continuously or intermittently to monitor water clarity. Or in the case of a variable speed motor, a continuous low speed can be selected to provide the filtering, oxidation and pH systems with a continuous stream of pool/spa/water feature water. Water circulations can be increased to “stir” or “disperse” chemicals, as needed, and as determined by the automatic controller, or maintenance personnel in manual override. The oxidation and pH may be tested using systems known in the art. The turbidity and/or suspended solids may be tested in accordance with the present system described in further detail below.

By determining the optimal filter rate with this closed loop technical system, a large cost saving may occur.

To measure the water clarity or turbidity, one or more sensors 120, such as a turbidity sensor and/or a suspended solid sensor, may be used. The one or more sensors 120 may be located within the plumbing 105 and measure the clarity of the water as it passes from the pump 108 to the filter 112. Alternatively, the one or more sensors 120 may be located at any other suitable location, for example, within the body of water. An output signal from the one or more sensors 120 may be provided as input to the system controller module 118. The system controller module 118 may then use this input to determine the optimal filter rate and time.

According to one example, the controller module may also determine if chemicals or disinfecting agents are to be added to the body of water 102. To kill the pathogens in the water, a disinfecting agent may be introduced into the water. The most popular pool disinfectant is chlorine, in the form of a chemical compound such as calcium hypochlorite (a solid) or sodium hypochlorite (a liquid). When the compound is added to the water, the chlorine reacts with the water to form various chemicals, most notably hypochlorous acid. Hypochlorous acid kills bacteria and other pathogens by attacking the lipids in the cell walls and destroying the enzymes and structures inside the cell through an oxidation reaction.

Upon a determination that chemicals are to be added, the system controller module 118 may instruct a clarifier chemical and pump module 122 to add a specific amount of chemicals (or clarifying agent) to the water in the water outlet 114 to be dispersed into the body of water 102. Maintaining the proper balance of chemicals in the pool is a continual process, because any new element, such as oils from a swimmer's body, dirt, leaves or anything else that may fall into the water and shift the water's total chemical makeup.

It is important to carefully manipulate the chemical balance in pools for several reasons including (1) Dangerous pathogens, such as bacteria, thrive in water. A pool filled with untreated water would be a perfect place for disease-carrying microorganisms to move from one person to another; (2) water with the wrong chemical balance can damage the various parts of the pool; (3) improperly balanced water can irritate the skin and eyes; and (4) improperly balanced water can get cloudy. Thus, the systems and methods described herein build upon the improvements provided by state of the art chemical controllers. Furthermore, the systems and methods described herein provide a means to improve upon water quality, using vastly lower electric energy than current “rule of the thumb” methods.

By utilizing this closed loop control filtration system 100, a specific or desired water clarity (turbidity, often specified in Nephelometric Turbidity Units (NTU)) can be maintained at the lowest possible cost.

### Exemplary Controller Module

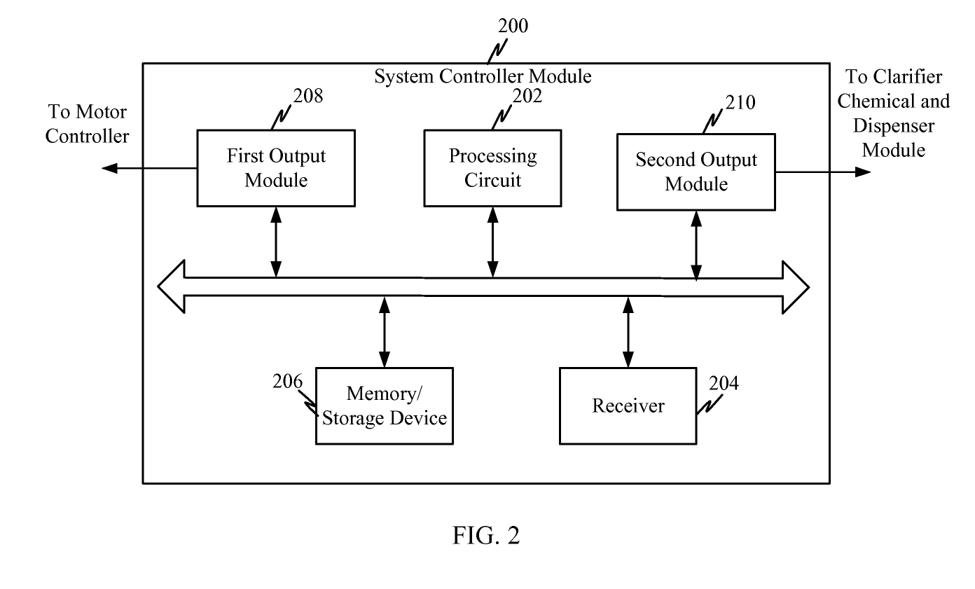

FIG. 2 illustrates a block diagram of an internal structure of a system controller module 200 according to one example. The system controller module 200 may include a processing circuit 202 (e.g., processor, processing module, etc.) coupled to a receiver 204 for receiving a measurement of water clarity from one or more sensors, such as but not limited to a turbidity sensor and/or suspended solid sensor, and a memory device 206 for storing water clarity measurements, desired water clarity and optimal filter rates.

The processing circuit 202 may also be coupled to a first output module (or transmitter) 208 for sending commands/signals to a motor controller (such as a variable-frequency drive (VFD) or direct current drive (DCD)) for controlling a motor of a filter and a second output module (or transmitter) 210 for sending commands/signals to a clarifier chemical and dispenser module for adding chemicals or disinfecting agents into the water.

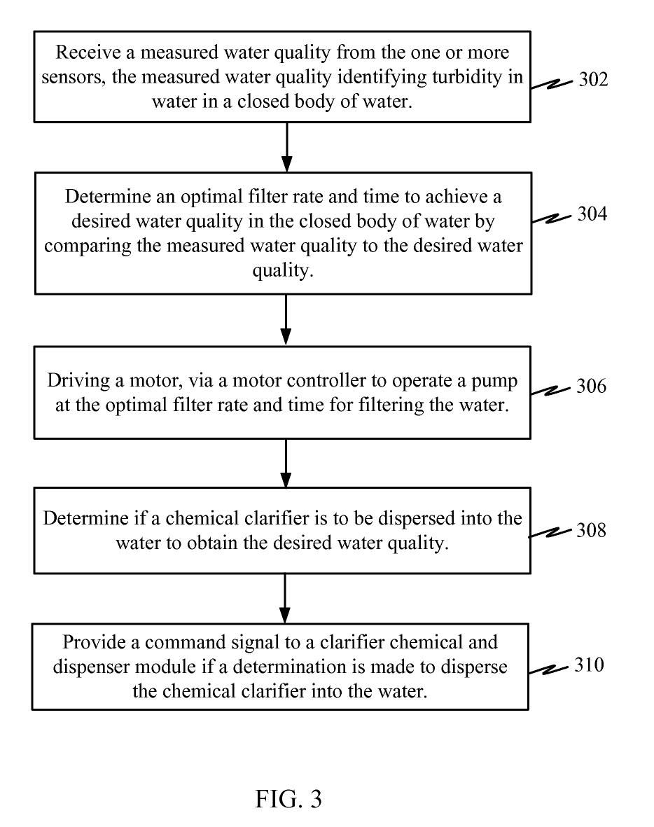

FIG. 3 illustrates a method operational on a controller module for optimizing water filtration in a closed body of water. The controller module may receive a measured water clarity value from one or more sensors, such as a turbidity sensor and/or a suspended solids sensor, mounted either in existing plumbing or utilizing sample chambers which continually samples the water, where the measured water clarity identifies turbidity in water in a closed body of water 302. Using the measured water clarity, an optimal filter rate and time may be determined to achieve a desired water clarity in the closed body of water by comparing the measured water clarity to the desired water clarity 304.

In other words, the current water clarity is measured and compared to the optimal or desired water clarity. Using the type of motor (for example single or multiple speed, or variable speed), the optimal operations of the motor needed to achieve the desired results can be determined. For example, it may be more cost effective and energy efficient to have the motor operate at a lower speed for a longer amount of time instead of having the motor operate at a higher speed for a short time.

In one example, the optimal filter rate signal may be determined using the following equation:

V=K+(1−ê(x/t))

where V is the optimal filter rate signal which may drive the VFD or DCD, K is a constant required to maintain a minimum filtering rate, x is a factor related to the size of the body of water and t is the time between the present moment and a future time (for example, at pool opening, the next day) that some water clarity level is required.

Once the optimal filter rate and time has been determined, the motor may be driven, via the motor controller (such as a variable frequency drive, direct current drive or contactor), commanding the motor to operate a pump at the optimal filter rate and time for filtering the water 306.

Optionally, a determination may be made by the system controller, as to whether to disperse a chemical clarifier into the water to obtain the desired water clarity 308. If a determination is made to disperse the chemical clarifier into the water, a command signal may be provided to a clarifier chemical and dispenser module to disperse the chemical 310.

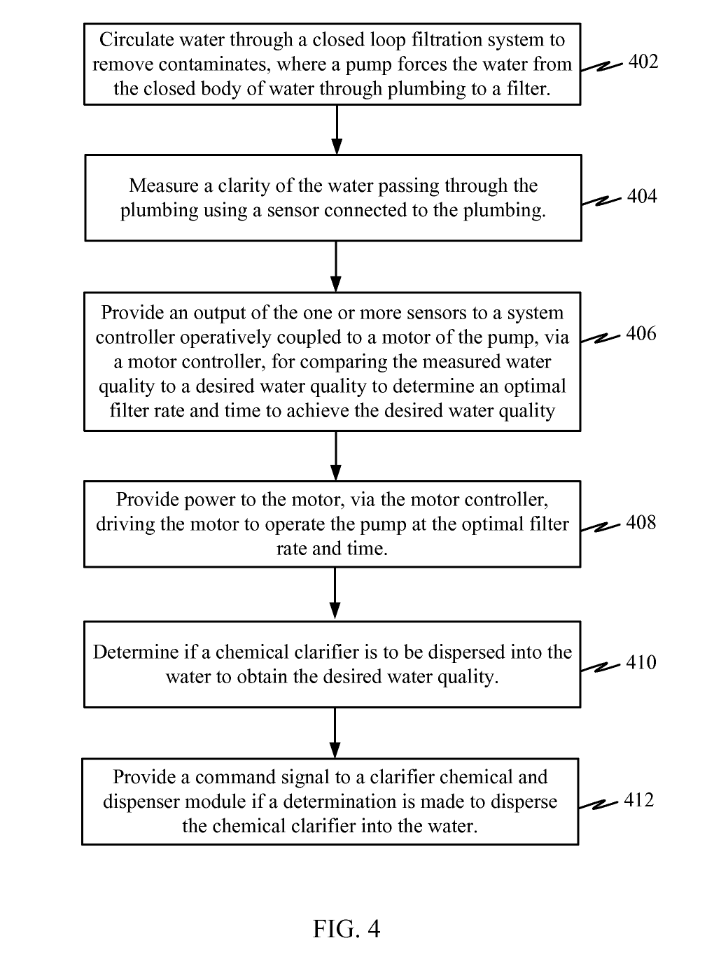

FIG. 4 illustrates a method for optimizing water filtration in a closed body of water. To filter water, the water may be circulated through a closed loop filtration system to remove contaminates, where a pump forces the water from the closed body of water through plumbing to a filter 402. When passing through the plumbing, the water clarity may be measured using one or more sensors connected to the plumbing 404 or other suitable location before the water passes through the filter. The one or more sensors may be a turbidity sensor and/or a suspended solids sensor.

The output of the one or more sensors may then be provided to a system controller module (or system controller) operatively coupled to a motor of the pump, via the motor controller, (such as a variable frequency drive, direct current drive, contactor or set of contactors), for comparing the measured water clarity to a desired water clarity to determine an optimal filter rate and time to achieve the desired water clarity 406. The optimal filter rate and time can be determined locally within the controller or in a network environment. Once an optimal filter rate is determined, power may be provided to the motor, via the motor controller or contactors to operate the pump at the optimal filter rate and time 408.

Optionally, a determination may be made as to whether to disperse a chemical clarifier into the water to obtain the desired water clarity 410. If a determination is made to disperse the chemical clarifier into the water, a command signal may be provided to a clarifier chemical and dispenser module to disperse the chemical 412.

The closed loop filtration system described above provides the ability to circulate and filter water in a closed body of water based on the current conditions of the water. That is, the filtration system is adjusted based on the clarity of the water providing both effective and efficient water circulation and filtration. When adjusting the filtration system, an optimal filter rate may be determined to find the most cost efficient and energy efficient way of operating the motor. As a result, the motor drives the filtration system so that it to uses the minimum amount of energy, given the type of motor, single or multiple speed, or variable speed, to maintain the turbidity at a specific level.

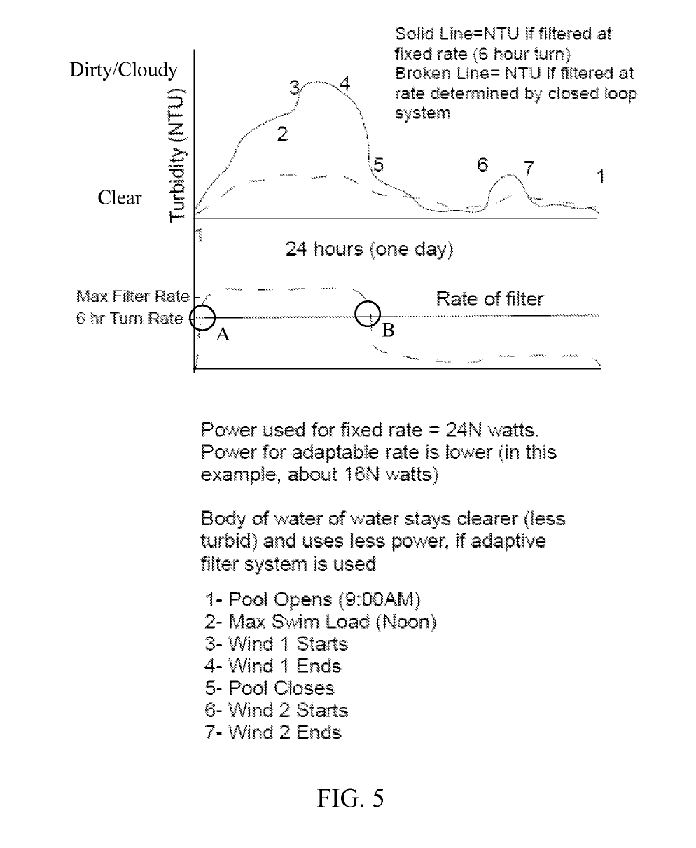

FIG. 5 is a graph illustrating the turbidity of water (specified in Nephelometric Turbidity Units (NTU)) in a closed body of water over a twenty four (24) hour period using conventional filtering methods and the closed loop control filtration system of the present invention. As shown, the y-axis of the graph represents the measured turbidity of the water (the higher the NTU the dirtier the water) and the x-axis of the graph represents a time period in hours. The solid line represents the turbidity of water when the water is filtered at a fixed rate (such as a 6 hour turn) using a conventional method while the broken line represents the turbidity of water when the water is filtered using the closed loop control filtration system of the present invention.

In this example, a typical 24 hour period of filtering pool is shown. The power used for the fixed rate may be 24N watts and the power for the adaptable rate may be lower, for example 16N watts. As shown in the legend in FIG. 5, the time period may begin when the body of water, such as a pool, opens, for example 9:00 AM (1) and the maximum usage or swim load may occur at noon (2). Shortly thereafter Wind Event 1 (for example, a short burst of wind which adds dust to pool) may start (3) and end (4) prior to the closing of the pool (5). After the pool closes, Wind Event 2 (for example, a short burst of wind which adds dust to pool) may start (6) and end (5) and then at the completion of the 24 hour period, the process again starts when the pool opens.

Also shown in FIG. 5 is a graph of the rate of the filter using conventional filtering methods and the closed loop control filtration system of the present invention. As is shown, with the closed loop filter system of the present invention, only twice was a 6 hour turn necessary and sufficient. The first 6 hour turn was necessary right after the opening of the pool (A) and the second 6 hour turn was necessary at the closing of the pool (B). Otherwise, from the closing (5) to the opening (1) of the pool, the rate of filter was much slower than the 6 hour turn rule of thumb (thus saving power versus the fixed state of the art system) and then from the opening of the pool (1) to the closing of the pool (5), the filter rate was at the maximum available, often 20% higher than the 6 hour rate (thus providing higher rate of filtering than an alternative solution locked at the state of the art 6 hour turn rate).

It should be recognized that, generally, most of the processing described in this disclosure may be implemented in a similar fashion. Any of the circuit(s) or circuit sections may be implemented alone or in combination as part of an integrated circuit with one or more processors. The one or more of the circuits may be implemented on digital or analog integrated circuits, an Advance RISC Machine (ARM) processor, a digital signal processor (DSP), a general purpose processor, a programmable logic controller (PLC), a PID or proportional-integral-derivative controller, etc.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by local or remote via networking, hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

One or more of the components, steps, and/or functions illustrated in the Figures may be rearranged and/or combined into a single component, step, or function or embodied in several components, steps, or functions. Additional elements, components, steps, and/or functions may also be added without departing from the invention. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software, local or remote, depends upon the particular application and design constraints imposed on the overall system.

The description of the embodiments is intended to be illustrative, and not to limit the scope of the claims. As such, the present teachings can be readily applied to other types of apparatuses and many alternatives, modifications, and variations will be apparent to those skilled in the art.

1. A method for optimizing water filtration in a closed body of water, comprising:
circulating the water through a closed loop filtration system to remove contaminates, where a pump forces the water from the closed body of water through plumbing to a filter;
measuring a clarity of the water passing through the plumbing using one or more sensors connected to the plumbing;
providing an output of the one or more sensors to a system controller operatively coupled to a motor of the pump, via a motor controller for comparing the measured water clarity to a desired water clarity to determine an optimal filter rate and time to achieve the desired water clarity; and
providing power to the motor, via the motor controller, driving the motor to operate the pump at the optimal filter rate and time.

2. The method of claim 1, wherein the one or more sensors measure the turbidity in the water and wherein the one or more sensors include at least one of a turbidity sensor and a suspended solids sensor.

3. The method of claim 1, wherein the motor is selected from the group consisting of a single speed motor, a multiple speed motor and a variable speed motor.

4. The method of claim 1, wherein the motor is an alternating current motor (AC) or a direct current (DC) motor.

5. The method of claim 1, further comprising:
determining if a chemical clarifier is to be dispersed into the water to obtain the desired water clarity; and
providing a command signal to a clarifier chemical and dispenser module if a determination is made to disperse the chemical clarifier into the water.

6. The method of claim 1, wherein determining the optimal filter rate and time includes selecting a speed in which to run or stop the motor and selecting a length of time in which to run the motor.

7. The method of claim 1, wherein the motor controller is at least one of a switch, contactor, variable-frequency drive (VFD) and direct current drive (DCD).

8. A filtration system for optimizing water filtration in a closed body of water, comprising:
means for circulating the water through a filtration system to remove contaminates, where a pump forces the water from the closed body of water through plumbing to a filter;
means for measuring a clarity of the water passing through the plumbing using one or more sensors connected to the plumbing;
means for providing an output of the one or more sensors to a system controller operatively coupled to a motor of the pump, via a motor controller for comparing the measured water clarity to a desired water clarity to determine an optimal filter rate and time to achieve the desired water clarity; and
means for providing power to the motor, via the motor controller, driving the motor to operate the pump at the optimal filter rate and time.

9. The system of claim 8, wherein the one or more sensors measure suspended solids in the water and wherein the one or more sensors include at least one of a turbidity sensor and a suspended solids sensor.

10. The system of claim 8, wherein the motor is selected from a group consisting of a single speed motor, a multiple speed motor and a variable speed motor.

11. The system of claim 8, wherein the one or more sensors measure suspended solids in the water.

12. The system of claim 8, further comprising:
means for determining if a chemical clarifier is to be dispersed into the water to obtain the desired water clarity; and
means for providing a command signal to a clarifier chemical and pump module if a determination is made to disperse the chemical clarifier into the water.

13. The system of claim 8, wherein determining the optimal filter rate and time includes selecting a speed in which to run or stop the motor and selecting a length of time in which to run the motor.

14. A controller module, comprising:
a memory device;
a receiver coupled to the memory device, the receiver for receiving data from one or more sensors; and
a processing circuit coupled to the memory device and the receiver, the processing circuit configured to:
receive a measured water clarity from the one or more sensors, the measured water clarity identifying turbidity in water in a closed body of water;
determine an optimal filter rate and time to achieve a desired water clarity in the closed body of water by comparing the measured water clarity to the desired water clarity; and
drive a motor, via a motor controller, to operate a pump at the optimal filter rate and time for filtering the water.

15. The controller module of claim 14, wherein the motor is selected from a group consisting of a single speed motor, a multiple speed motor and a variable speed motor.

16. The controller module of claim 14, wherein the processing circuit is further configured to:
determine if a chemical clarifier is to be dispersed into the water to obtain the desired water clarity; and
provide a command signal to a clarifier chemical and dispenser module if a determination is made to disperse the chemical clarifier into the water.

17. The controller module of claim 16, wherein the command signal is transmitted to the clarifier chemical and dispenser module via a second transmitter, the second transmitter coupled to the processing circuit.

18. The controller module of claim 14, wherein control signals are transmitted to the motor controller via a first transmitter, the first transmitter coupled to the memory device and the processing circuit.

19. The controller module of claim 14, wherein determining the optimal filter rate includes selecting a speed in which to run the motor and selecting a length of time in which to run the motor.

20. The controller module of claim 14, wherein the optimal filter rate and time are determined locally or in a network environment.
